(19) United States
(12) Patent Application Publication
(10) Pub. No.: US 2017/0195065 A1
(43) Pub. Date: Jul. 6, 2017

(54) OPTO-ISOLATOR THAT USES A GENERALLY RIGID STRUCTURE FOR BOARD-TO-BOARD ALIGNMENT AND OPTICAL COUPLING

(71) Applicant: Avago Technologies General IP (Singapore) Pte. Ltd., Singapore (SG)

(72) Inventors: Joerg Meier, Burgthann (DE); Marcin Maros, Regensburg (DE); Markus Stich, Obertraubling (DE); Christian Gaertner, Regensburg (DE); Tim Schnitzler, Oberreichenbach (DE); Josef Wittl, Parsberg (DE)

(21) Appl. No.: 14/986,302

(22) Filed: Dec. 31, 2015

(51) Int. Cl. H04B 10/80; H04B 10/25

(52) U.S. Cl. CPC H04B 10/802; H04B 10/2504

(57) ABSTRACT

An opto-isolator is provided that is designed for optically interconnecting devices that are mounted on multiple PCBs. The opto-isolator is particularly well suited for arrangements where the PCB-to-PCB distance is very small. In such cases, using an optical fiber as the optical waveguide can result in the optical fiber being bent beyond its minimum bend radius, resulting in damage to the optical fiber and/or performance problems due to attenuation of the optical signal. The opto-isolator includes first and second generally rigid structures that engage one another with an alignment tolerance that ensures proper board-to-board alignment while also facilitating the ease with which the alignment process can be performed. Once the first and second generally rigid structures are in engagement with one another, they form a generally rigid optical waveguide structure for coupling light from an optical transmitter of one of the PCBs onto an optical receiver of the other PCB.

### TECHNICAL FIELD OF THE INVENTION

The invention relates to opto-isolators. More particularly, the invention relates to an opto-isolator that utilizes a generally rigid structure for coupling optical signals between devices mounted on multiple printed circuit boards (PCBs) and for aligning the optical ports of the PCBs with one another.

### BACKGROUND OF THE INVENTION

An opto-isolator is a device that transfers a signal optically between two electrical circuits operating at different electrical potentials while, at the same time, electromagnetically isolating the circuits from each other. Opto-isolators also isolate one part of a system from electrical noise in another part of the system and protect circuits against damage from voltage surges. A transmitter module of the opto-isolator comprises an electrical-to-optical converter (EOC), such as a visible or infrared light emitting diode (LED), for example, that converts an electrical driver signal into an optical signal. A receiver module of the opto-isolator comprises an optical-to-electrical converter (OEC), such as a photodiode, for example, that converts the optical signal back into an electrical signal.

An optical waveguide optically couples the transmitter and receiver modules to each to allow optical signals produced by the EOC of the transmitter module to be transmitted to the OEC of the receiver module. The optical waveguide is typically a length of optical fiber, but other optical waveguides are sometimes used for this purpose. For example, it is known to use an optically transmissive rod as the optical waveguide surrounded by a fluid having a refractive index that is different from the refractive index of the rod.

Although these types of opto-isolators generally work well at coupling optical signals between the transmitter and receiver modules, if an attempt is made to use them to optically interconnect devices mounted on multiple PCBs that are in close proximity to one another, e.g., stacked one on top of the other, the optical fiber may be bent beyond its minimum bend radius, resulting in damage to the optical fiber and/or performance problems due to attenuation of the optical signal carried on the optical fiber. In addition, in cases in which the PCBs are very close to one another, it is difficult connect the end of the optical fiber to the receptacle on the receiving PCB, which creates difficulties during the assembly process. In such cases, the end of the fiber is typically connected to the port on the receiving PCB prior to mounting the PCB in a rack or stacking the PCBs, and thus constitutes an additional assembly step.

Accordingly, a need exists for an opto-isolator that is well suited for optically interconnecting devices that are mounted on multiple PCBs that are in close proximity to one another.

### BRIEF DESCRIPTION OF THE DRAWINGS

FIG. 1 illustrates a schematic side view of portions of two PCBs that are optically interconnected by an opto-isolator in accordance with an illustrative embodiment.

FIG. 2 illustrates an enlarged view of the portion of the opto-isolator contained in FIG. 1 in the dashed circle 25.

FIG. 3 illustrates a cross-sectional perspective view of the opto-isolator shown in FIG. 1 in accordance with an illustrative embodiment.

FIG. 4 illustrates a perspective view of the optional EMI shielding gasket of the opto-isolator shown in FIG. 3.

FIG. 5 illustrates a side schematic view of the opto-isolator 60 in accordance with another illustrative embodiment.

FIG. 6 illustrates a schematic side view of portions of two PCBs that are optically interconnected by the opto-isolator in accordance with another illustrative embodiment.

### WRITTEN DESCRIPTION

In accordance with the invention, an opto-isolator is provided that is designed for optically interconnecting devices that are mounted on multiple PCBs. The opto-isolator is particularly well suited for arrangements where the PCB-to-PCB distance is very small. In such cases, using an optical fiber as the optical waveguide can result in the optical fiber being bent beyond its minimum bend radius, resulting in damage to the optical fiber and/or performance problems due to attenuation of the optical signal. The opto-isolator includes first and second generally rigid structures that engage one another with an alignment tolerance that ensures proper board-to-board alignment while also facilitating the ease with which the alignment process can be performed. Once the first and second generally rigid structures are in engagement with one another, they form a generally rigid optical waveguide structure for coupling light from an optical transmitter (Tx) located on one of the PCBs onto an optical receiver (Rx) located on the other PCB.

When using an opto-isolator to interconnect two PCBs, the alignment tolerances of the PCBs and the effects of shock and vibration on the PCBs should be taken into account. If a rigid or fixed interconnection with no tolerances is used to interconnect the PCBs, establishing the interconnection will be extremely difficult and the interconnection will be susceptible to being damaged by mechanical stress or shock. In accordance with embodiments described herein, the interconnecting parts of the opto-isolator are made to have predetermined dimensional tolerances that facilitate making the interconnections between the parts when the PCBs are aligned with one another and assembled in a stacked or a side-by-side arrangement. The predetermined dimensional tolerances also help prevent the interconnection and/or the PCBs from being adversely affected by mechanical stress or shock. Illustrative, or exemplary, embodiments will now be described with reference to the figures, in which like reference numerals represent like elements, components or features.

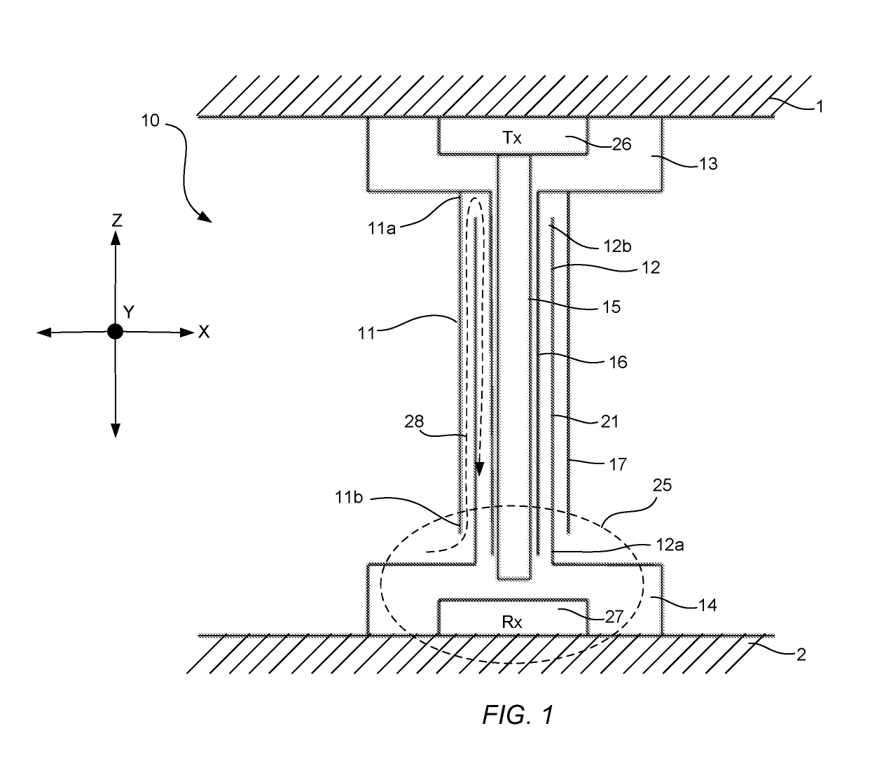

FIG. 1 illustrates a schematic side view of portions of two PCBs 1 and 2 that are optically interconnected by the opto-isolator 10 in accordance with an illustrative embodiment. In accordance with this illustrative embodiment, the opto-isolator 10 comprises first and second generally rigid structures 11 and 12, respectively. In accordance with this embodiment, the first and second generally rigid structures 11 and 12, respectively, are made of a hard plastic material, although other suitable materials may be used for this purpose. The first generally rigid structure 11 has a proximal end 11a that is joined to, or mechanically coupled with, a first housing 13 and a distal end 11b that extends in a direction away from the first housing 13. The second generally rigid structure 12 has a proximal end 12a that is joined to, or mechanically coupled with, a second housing 14 and a distal end 12b that extends in a direction away from the housing 14.

In accordance with this illustrative embodiment, the portion of the first generally rigid structure 11 in between the proximal and distal ends 11a and 11b, respectively, comprises a first optical waveguide 15, a first pipe structure 16 that surrounds the first optical waveguide 15, and a second pipe structure 17 that surrounds the first pipe structure 16. In accordance with this illustrative embodiment, the first optical waveguide 15 is a glass or plastic rod. The first optical waveguide 15 and the first and second pipe structures 16 and 17 are all coaxial with one another such that an optical axis of the first optical waveguide 15 coincides with the respective axes of the first and second pipe structures 16 and 17, respectively. In accordance with this illustrative embodiment, the first housing 13 and the first and second pipe structures 16 and 17 are all integrally formed together as a single, or unitary, piece part. For example, these components may be formed as a single piece of molded plastic using a known plastic molding process.

The second generally rigid structure 12 comprises the housing 14 and a third pipe structure 21, which, in accordance with this illustrative embodiment, is integrally formed with the housing 14 as a single piece part (e.g., a molded plastic piece part). In accordance with this illustrative embodiment, the third pipe structure 21 surrounds the first pipe structure 16 when the first and second generally rigid structures 11 and 12 are engaged with one another as shown in FIG. 1. In this engaged configuration, the third pipe structure 21 is located in between the first and second pipe structures 16 and 17, respectively.

The first housing 13 houses an optical Tx 26, which may be, for example, a vertical cavity surface emitting laser diode (VCSEL) or some other type of light source, such as a light emitting diode (LED) or an edge-emitting laser diode. The second housing 14 houses an optical Rx 27, which may be, for example, a P-type-intrinsic-N-type (PIN) diode.

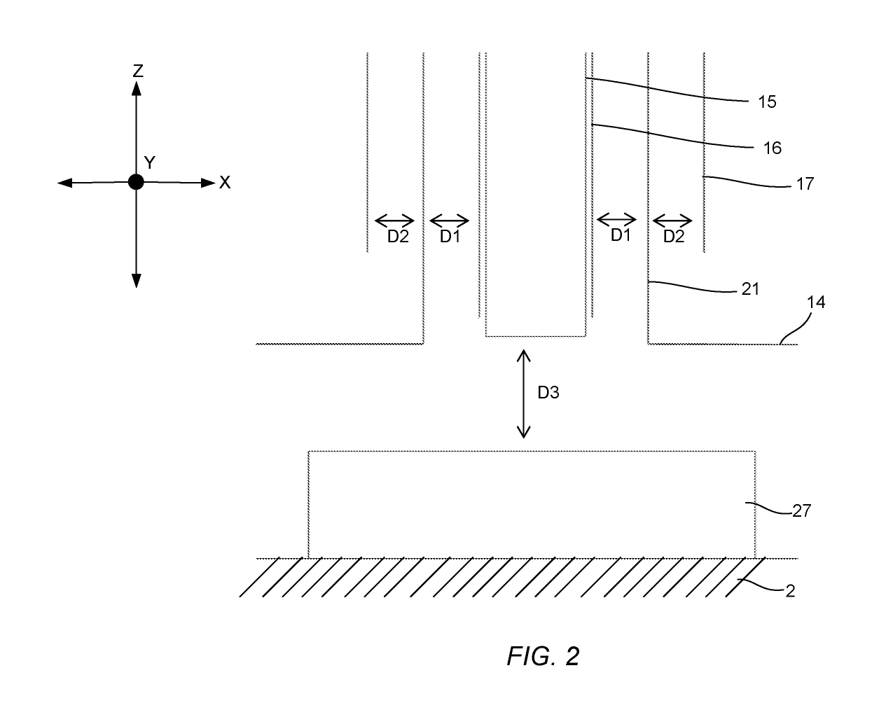

FIG. 2 illustrates an enlarged view of the portion of the opto-isolator 10 contained in FIG. 1 in the dashed circle 25. The distance D1 is the distance between an outer surface of the first pipe structure 16 of the first generally rigid structure 11 and an inner surface of the third pipe structure 21 of the second generally rigid structure 12. The distance D2 is the distance between an outer surface of the third pipe structure 21 of the second generally rigid structure 12 and an inner surface of the second pipe structure 17 of the first generally rigid structure 11. The distance D3 is the distance between the distal end of the first waveguide 15 and the optical Rx 27. In accordance with this illustrative embodiment, the first optical waveguide 15 and the first, second and third pipe structures 16, 17 and 21, respectively, are assumed to be cylindrically shaped and to have respective diameters that are different from one another. Therefore, with respect to the X, Y, Z Cartesian coordinate system shown in FIG. 2, the distances D1 and D2 correspond to distances in both the X and Y dimensions, whereas the distance D3 corresponds to the distance in the Z dimension. In accordance with this illustrative embodiment, there is also Z-dimensional tolerance with respect to distance D3, although in some embodiments there may only be dimensional tolerance in the X and Y dimensions.

The first and second generally rigid structures 11 and 12 are manufactured to ensure that the preselected distances D1-D3 are large to provide wide dimensional tolerances for aligning and engaging the structures 11 and 12 with one another. These wide dimensional tolerances allow the structures 11 and 12 to passively engage one another during the process of stacking the PCBs 1 and 2 one atop the other or side by side. This feature obviates the aforementioned additional assembly step of having to make a connection between an end of an optical fiber and the optical port on the receiving PCB prior to installing the PCB in a rack or other PCB-array arrangement. In essence, the first, second and third pipe structures 16, 17 and 21, respectively, act as guides that engage one another to bring the distal end of the first waveguide 15 into optical alignment with the optical Rx 27.

The wide dimensional tolerances allow an installer to easily engage the gap between the first and second pipe structures 16 and 17 with the distal end of the third pipe structure 21 and to then to bring the pipe structures 16, 17 into full engagement with the third pipe structure 21 by urging the first and second PCBs 1 and 2 toward one another. For example, the act of stacking the PCB 1 atop the PCB 2 after visually aligning the structures 11 and 12 with one another will result in the structures 11 and 12 fully engaging one another. There are limits on the wide dimensional tolerances to prevent an impermissible amount of misalignment from occurring between the distal end of the first optical waveguide 15 and the optical Rx 27. Additionally, full engagement of the generally rigid structures 11 and 12 with one another provides mechanical stability to the PCB-to-PCB arrangement in that the engaged structures 11 and 12 are capable of absorbing shock and mechanical vibrations.

Another benefit of the opto-isolator 10 shown in FIGS. 1 and 2 is that the positioning of the third pipe structure 21 in between the first and second pipe structures 16 and 17, respectively, provides an optical barrier that prevents light from external sources from entering the interior of the opto-isolator 10. With reference again to FIG. 1, the path of external light from an external source is represented by the dashed arrow labeled with reference numeral 28. It can be seen that in order for the light 28 to reach the optical Rx 27, the light 28 must enter the space in between the second and third pipe structures 17 and 21 near the distal and proximal ends 11b and 12a of the generally rigid structures 11 and 12, respectively, and travel around the opposite end of the third pipe structure 21 near the proximal end 11a of the generally rigid structure 11 before the light 28 has a chance of traveling toward the optical Rx 27. The nature of this light pathway makes it highly unlikely that any light 28 will reach the optical Rx 27 because most of the light 28 will be reflected and/or absorbed at the points where the light pathway turns.

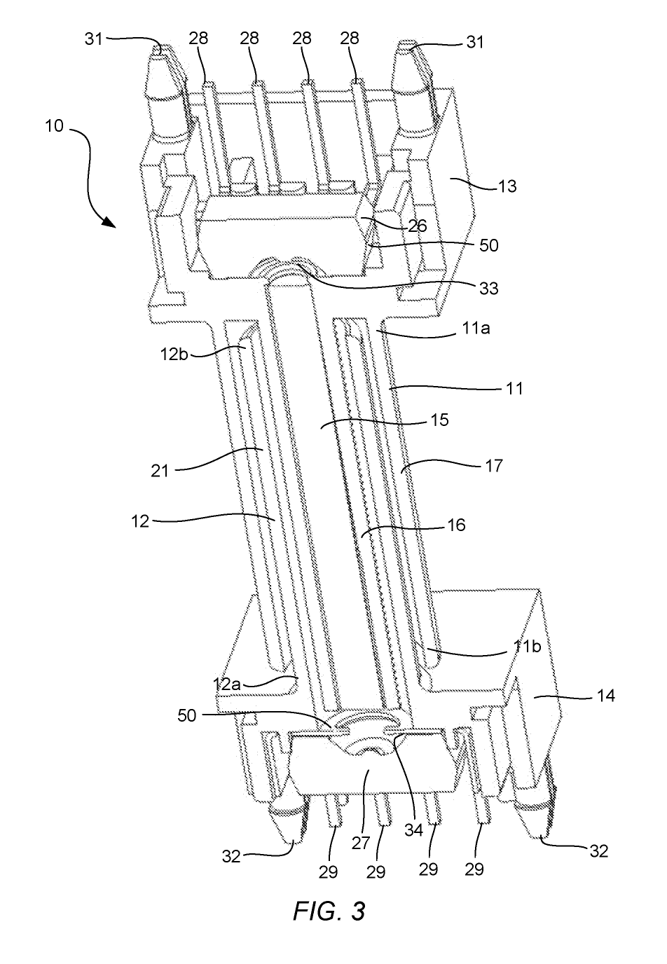

FIG. 3 illustrates a cross-sectional perspective view of the opto-isolator 10 shown in FIG. 1 in accordance with an illustrative embodiment. The first and second housings 13 and 14, respectively, have mating features 31 and 32 thereon, respectively, that are adapted to mate with complementarily-shaped openings (not shown) of the PCBs 1 and 2, respectively. In accordance with this illustrative embodiment, the first pipe structure 16 has first and second stoppers 33 and 34 disposed at opposite ends thereof for Z-dimensional alignment. The first and second stoppers 33 and 34 are typically made of material that has some degree of flexibility, such as rubber or plastic, for example.

During manufacturing of the first generally flexible structure 11, the glass or plastic rod that acts as the first optical waveguide 15 is inserted through the distal end of the first pipe structure 16 until the proximal end of the first optical waveguide 15 abuts the first stopper 33. It should be noted that the first optical waveguide may also be a length of optical fiber that is secured within the first pipe structure 16. Alternatively, the first optical waveguide 15 may be a reflective inner surface of the first pipe structure 16 that guides the light from the optical Tx 26 to the optical Rx 27 via reflection against the inner surface of the first pipe structure 16. In the latter case, the inner surface of the first pipe structure 16 would have suitably reflective properties for the operational wavelength of light being used. For exemplary purposes, it will be assumed that the first optical waveguide 15 is a plastic or glass or rod.

The rod 15 is held in place inside of the first pipe structure 16 by a friction fit that exists between the rod 15 and the inner surface of the first pipe structure 16 and/or by an adhesive material such as epoxy, for example, that adheres the outer surface of the rod 15 to the inner surface of the first pipe structure 16. The rod 15 may have protrusions (not shown) extending along a portion of its outer surface that create a press fit with the inner surface of the first pipe structure 16 when the rod 15 is pressed into the first pipe structure 16. In the latter case, the rod 15 is held in position by the press fit.

When the first generally rigid structure 11 is fully engaged with the second generally rigid structure 12, as shown in FIG. 1, the distal end of the first optical waveguide 15 is in abutment with the second stopper 34. In accordance with an illustrative embodiment, the opto-isolator 10 includes optional electromagnetic interference (EMI) shielding gaskets 50 that are sandwiched in between the chip packages of the optical Tx 26 and optical Rx 27 and the respective housings 13 and 14. The first and second stoppers 33 and 34 are in contact with only the peripheral edges of the proximal and distal ends, respectively, of the rod 15 so that the stoppers 33 and 34 do not block the optical pathway of the rod 15. The EMI shielding gaskets 50 also have openings formed in them where the gaskets 50 meet the ends of the rod 15 so that they do not occlude the optical pathway of the rod 15. The gaskets 50 also have openings formed in them on the opposite sides through which electrically-conductive leads 28 and 29 of the optical Tx 26 and Rx 27, respectively, pass to make electrical contact with electrical contacts (not shown) of the PCBs 1 and 2.

The stoppers 33 and 34 ensure that the proximal and distal ends, respectively, of the rod 15 are at predetermined, respective distances from the optical Tx 26 and Rx 27, respectively (i.e., distance D3 in FIG. 2). This aligns the proximal and distal ends of the rod 15 with the optical Tx 26 and Rx 27 in the Z dimension (FIG. 2). The stoppers 33 and 34 are optional, but they are useful in helping maintain Z-dimensional alignment over changes in temperature and when mechanical vibrations occur. The flexibility of the stoppers 33 and 34 provides adequate Z-dimensional alignment tolerance. The stoppers 33 and 34 also prevent the proximal and distal ends of the rod 15 from coming into contact with the optical Tx 26 and the optical Rx 27, respectively, which could result in damage to the proximal and distal ends of the rod 15 and/or to the optical Tx 26 and optical Rx 27. Also, if lenses are used to couple light between the proximal and distal ends of the rod 15 and the optical Tx 26 and optical Rx 27, respectively, the stoppers 33 and 34 prevent the ends of the rod 15 from coming into contact with the lenses and possibly damaging the lenses and/or the rod 15.

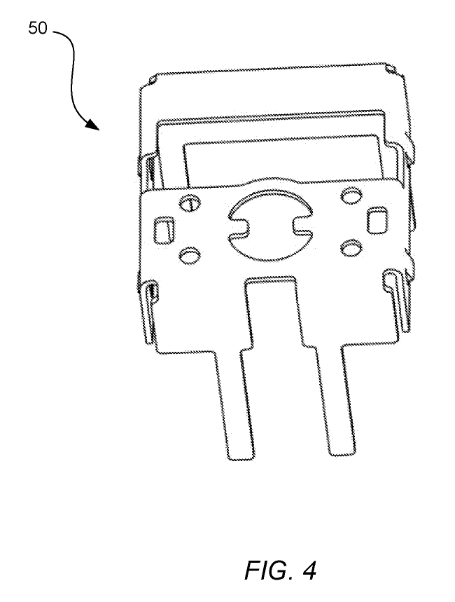

FIG. 4 illustrates a perspective view of the optional EMI shielding gasket 50 shown in FIG. 3. The EMI shielding gasket 50 is made of an electrically-conductive material such as metal, for example. Because the first and second generally rigid structures 11 and 12 are typically made of a non-electrically-conductive material (e.g., plastic), EMI radiation that enters the opto-isolator 10 will pass through the first and second generally rigid structures 11 and 12 into the environment. The EMI shielding gasket 50 prevents or at least reduces EMI leakage from the electrical components of the PCBs 1 and 2 into the opto-isolator 10. The EMI shielding gasket 50 has a shape that is generally complementary to the portions of the chip packages of the optical Tx 26 and Rx 27 to which the gaskets 50 attach.

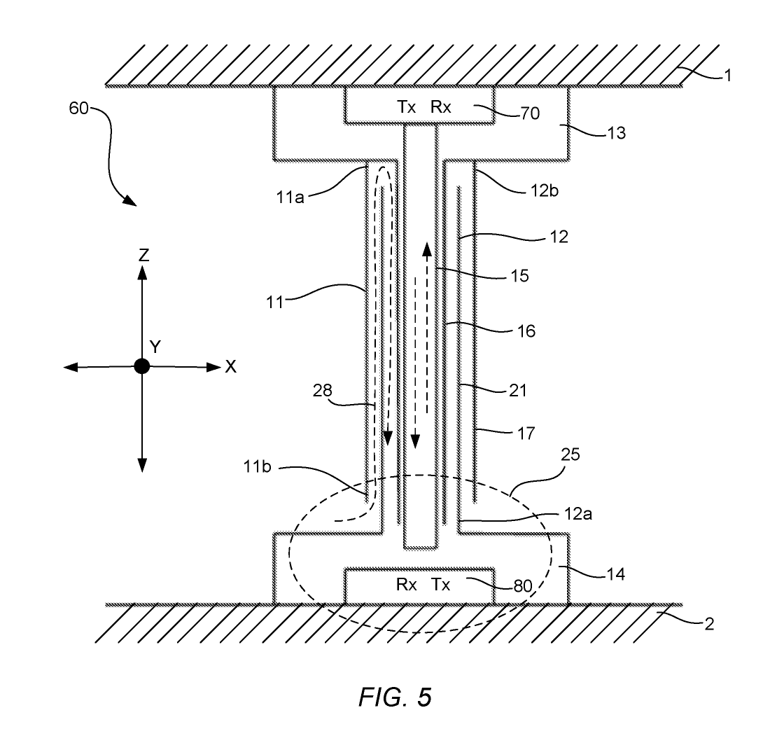

FIG. 5 illustrates a side schematic view of the opto-isolator 60 in accordance with another illustrative embodiment. In accordance with this embodiment, the optical Tx 26 and Rx 27 shown in FIGS. 1-3 have been replaced with first and second optical transceivers 70 and 80, respectively. The optical transceivers 70 and 80 each have both an optical Tx and an optical Rx such that the opto-isolator 60 is capable of bi-directional (BiDi) optical communications between the PCBs 1 and 2. In all other respects, the opto-isolator 60 may be identical to the opto-isolator 10 shown in FIG. 1. The optical transceiver 70 transmits light at a first wavelength, λ1, and receives light of a second wavelength, λ2. The optical transceiver 80 transmits light at the second wavelength, λ2, and receives light of the first wavelength, λ1.

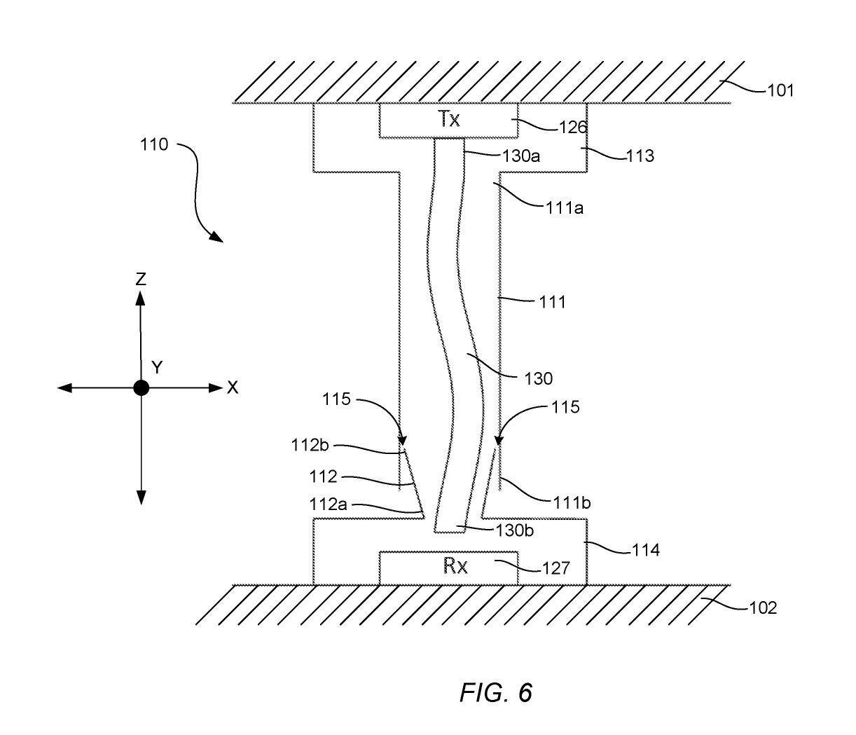

FIG. 6 illustrates a schematic side view of portions of two PCBs 101 and 102 that are optically and mechanically interconnected by the opto-isolator 110 in accordance with another illustrative embodiment. In accordance with this illustrative embodiment, the opto-isolator 110 comprises first and second generally rigid structures 111 and 112, respectively. In accordance with this embodiment, the first and second generally rigid structures 111 and 112, respectively, are made of a hard plastic material, although other suitable materials may be used for this purpose. The first generally rigid structure 111 has a proximal end 111a that is joined to, or mechanically coupled with, a first housing 113 and a distal end 111b that extends in a direction away from the first housing 113, which houses an optical Tx 126. The first generally rigid structure 111 may be a cylindrically-shaped pipe structure similar to the pipe structures 16, 17 and 21 shown in FIG. 1. Typically, the first generally rigid structure 111 and the housing 113 are integrally formed as a single piece part, e.g., a single piece of molded plastic.

The second generally rigid structure 112 has a proximal end 112a that is joined to, or mechanically coupled with, a second housing 114 and a distal end 112b that extends in a direction away from the housing 114. Typically, the second generally rigid structure 112 and the housing 114 are integrally formed as a single piece part, e.g., a single piece of molded plastic. The second housing 114 houses an optical Rx 127. The second generally rigid structure 112 may also be a pipe structure, except that in contrast to the pipe structures 16, 17, 21 and 111, the second generally rigid structure 112 has an inner diameter that varies over the length of the second generally rigid structure 112. The inner diameter is smaller near the proximal end 112a of the second generally rigid structure 112 and larger at the distal end 112b of the second generally rigid structure 112. At its distal end 112b, the inner diameter of the second generally rigid structure 112 is almost equal to, but slightly less than, the inner diameter of the first generally rigid structure 111, which is constant over the length of the structure 111. In accordance with this illustrative embodiment, the inner and outer diameters of the second generally rigid structure 112 increase linearly along its length. In other words, the second generally rigid structure 112 tapers outwardly in a linear fashion in the direction from its proximal end 112a to its distal end 112b.

At its distal end 112b, the outer diameter of the second generally rigid structure 112 is less than the inner diameter of the first generally rigid structure 111 such that a gap 115 exists between the inner surface of the first generally rigid structure 111 and the outer surface of the second generally rigid structure 112. This gap 115 is a result of the first and second generally rigid structures 111 and 112, respectively, being made with dimensions that provide predetermined dimensional tolerances in the X and Y dimensions that facilitate the process of aligning and engaging the structures 111 and 112 with one another.

The opto-isolator 110 has a first optical waveguide 130, which in this case is a length of plastic or glass optical fiber. A proximal end 130a of the optical fiber 130 is secured to the first housing 113 and the distal end 130b of the optical fiber 130 is secured to the second housing 114. The tapered shape of the second generally rigid structure 112 acts as a funnel that directs the distal end 130b of the optical fiber 130 toward the optical Rx 127 to achieve optical alignment. As with the opto-isolator 60 shown in FIG. 5, the opto-isolator 110 may use optical transceivers in place of the optical Tx 126 and Rx 127 to provide BiDi optical communications between the first and second PCBs 101 and 102.

It should be noted that the illustrative embodiments of the opt-isolators 10, 60 and 110 are examples that are intended to demonstrate principles and concepts of the invention, but other opto-isolator configurations are possible. The invention is not limited to these embodiments, as will be understood by those skilled in the art in view of the description provided herein. Other variations and modifications may be made to the embodiments described herein, as will be understood by those skilled in the art, and all such modifications and variations are within the scope of the invention.

What is claimed is:

1. An opto-isolator comprising:
a first generally rigid structure having a first housing, a first body and an optical waveguide, the first body having a proximal end and a distal end, the optical waveguide extending from the first housing toward the distal end, the proximal end being mechanically coupled to the first housing, the first housing being mechanically coupled to a first circuit board, the distal end extending away from the first housing, the first housing having at least a first optical transmitter device therein; and
a second generally rigid structure having a second housing and a second body, the second body having a proximal end and a distal end, the proximal end of the second body being mechanically coupled to the second housing, the second housing having an optical receiver device therein, the second housing being mechanically coupled to a second circuit board, the distal end of the second body extending away from the second housing and engaging the first generally rigid structure, the distal end of the first body engaging the second generally rigid structure, the first and second bodies having predetermined dimensional tolerances that ensure that space exists between the first and second bodies when the distal ends of the first and second bodies are engaged with the second and first generally rigid structures, respectively, and wherein light transmitted by the first optical transmitter device travels within the optical waveguide, passes out of a distal end of the optical waveguide and is incident on the first optical receiver device.

2. The opto-isolator of claim 1, wherein the first housing and the first body are integrally formed as a single piece part of plastic material and wherein the second housing and the second body are integrally formed as a single piece part of plastic material.

3. The opto-isolator of claim 1, wherein the first body comprises a cylindrically-shaped first pipe structure, and wherein the first optical waveguide is a generally rigid rod, a proximal end of the first optical waveguide coinciding with the proximal end of the first body, the first pipe structure surrounding the generally rigid rod along most or all of a length of the generally rigid rod.

4. The opto-isolator of claim 3, wherein the second body comprises at least a cylindrically-shaped second pipe structure having a proximal end and a distal end, the proximal end of the second pipe structure coinciding with the proximal end of the second body, the second pipe structure surrounding the first pipe structure along most or all of a length of the first pipe structure, wherein said space includes space that exists in between an inner surface of the second pipe structure and an outer surface of the first pipe structure.

5. The opto-isolator of claim 4, wherein the first body further comprises at least a cylindrically-shaped third pipe structure having a proximal end and a distal end, the proximal end of the third pipe structure coinciding with the proximal end of the first body, the third pipe structure surrounding the first and second pipe structures along most or all of respective lengths of the first and second pipe structures, wherein said space includes space that exists in between an inner surface of the third pipe structure and an outer surface of the second pipe structure.

6. The opto-isolator of claim 5, wherein the proximal ends of the first and second pipe structures are joined with the first and second housings, respectively, and wherein the proximal end of the third pipe structure is joined with the first body, the distal ends of the second and third pipe structures being positioned near the first and second housings, respectively, the distal end of the first pipe structure being positioned near the second housings.

7. The opto-isolator of claim 1, wherein the first optical waveguide comprises an optical fiber.

8. The opto-isolator of claim 1, wherein the first optical waveguide comprises a reflective surface disposed on an inner surface of the first pipe structure.

9. The opto-isolator of claim 1, wherein the first housing also has at least a second optical receiver device therein, and wherein the second housing also has at least a second optical transmitter device therein, and wherein light transmitted by the second optical transmitter device travels within the optical waveguide, passes out of the proximal end of the optical waveguide and is incident on the second optical receiver device.

10. The opto-isolator of claim 1, wherein the predetermined dimensional tolerances ensure that space exists between the first and second bodies in at least first and second directions that are perpendicular to an optical axis of the optical waveguide.

11. The opto-isolator of claim 1, wherein the predetermined dimensional tolerances ensure that space exists between the first and second bodies in at least first, second and third directions, the first and second directions being perpendicular to an optical axis of the optical waveguide, the third direction being parallel to the optical axis of the optical waveguide.

12. The opto-isolator of claim 1, wherein the first body comprises a cylindrically-shaped first pipe structure, and wherein the optical waveguide is an optical fiber having a proximal end and a distal end, the first pipe structure surrounding the optical fiber along most or all of a length of the optical waveguide, and wherein the second body has a tapered shape having a first inner diameter at the proximal end of the second body and having a second inner diameter at the distal end of the second body that is larger than the first inner diameter.

13. The opto-isolator of claim 12, wherein the second body has a first outer diameter at the proximal end of the second body and has a second outer diameter at the distal end of the second body that is larger than the first outer diameter.

14. The opto-isolator of claim 13, wherein the predetermined dimensional tolerances ensure that space exists between the first and second bodies in at least first and second directions that are perpendicular to an optical axis of the optical waveguide.

15. The opto-isolator of claim 1, further comprising first and second electromagnetic interference (EMI) sealing gaskets, the first and second EMI sealing gaskets being made of an electrically-conductive material, the first EMI sealing gasket being disposed in between a proximal end of the optical waveguide and the optical Tx device, the second EMI sealing gasket being disposed in between a distal end of the optical waveguide and the optical Rx device, the first and second EMI sealing gaskets having openings formed therein where the first and second EMI sealing gaskets intersect an optical axis of the optical waveguide.

16. An opto-isolator comprising:
a first circuit board;
a first housing, a cylindrically-shaped, generally rigid first pipe structure, and an optical waveguide, the first pipe structure having a proximal end and a distal end, the first pipe structure and the first housing being integrally formed as a single piece part, the first housing having at least one mating feature thereon that is mated with a respective mating feature of the first circuit board, the optical waveguide being surrounded by the first pipe structure and having a proximal end disposed in the first housing and a distal end extending away from the first housing toward the distal end of the first pipe structure, the optical waveguide having an optical axis that is coaxial with a longitudinal axis of the first pipe structure, the first housing having at least a first optical transmitter device therein;
a second circuit board; and
a second housing and a cylindrically-shaped second pipe structure, the second pipe structure having a proximal end and a distal end, the second pipe structure and the second housing being integrally formed as a single piece part, the second housing having an optical receiver device therein, the second housing having at least one mating feature thereon that is mated with a respective mating feature of the second circuit board, the first and second pipe structure being engaged with one another such that the second pipe structure surrounds the first pipe structure, the first and second structures having predetermined dimensional tolerances that ensure that space exists between the first and second pipe structures, and wherein light transmitted by the first optical transmitter device travels within the optical waveguide, passes out of the distal end of the optical waveguide and is incident on the first optical receiver device.

17. The opto-isolator of claim 16, further comprising at least a cylindrically-shaped third pipe structure integrally formed with the first housing and the first pipe structure as an integrally formed single piece part, the third pipe structure having a proximal end that is connected to the first housing and a distal end that extends away from the first housing, the third pipe structure surrounding the second pipe structure along most or all of a length of the second pipe structure, wherein the third pipe structure has a predetermined dimensional tolerance that ensures that space exists in between an inner surface of the third pipe structure and an outer surface of the second pipe structure.

18. The opto-isolator of claim 17, wherein the first housing also has at least a second optical receiver device therein, and wherein the second housing also has at least a second optical transmitter device therein, and wherein light transmitted by the second optical transmitter device travels within the optical waveguide, passes out of the proximal end of the optical waveguide and is incident on the second optical receiver device.

19. The opto-isolator of claim 17, wherein the optical waveguide is an optical fiber having a proximal end and a distal end, the first pipe structure having an inner diameter and an outer diameter, the second pipe structure having an inner diameter and an outer diameter, the inner and outer diameters of the first pipe structure being constant along a length of the first pipe structure, the inner and outer diameters of the second pipe structure varying along a length of the second pipe structure such that the second pipe structure has a tapered shape that is narrower at the proximal end of the second pipe structure and wider at the distal end of the second pipe structure, the inner diameter of the second pipe structure being smaller at the proximal end of the second pipe structure and larger at the distal end of the second pipe structure, and wherein a gap exists between the distal end of the second pipe structure and an inner surface of the first pipe structure.

20. A method for performing opto-isolation in a circuit board-to-circuit board arrangement, the method comprising:
mechanically and optically coupling a first circuit board with a second circuit board by engaging a first generally rigid structure of an opto-isolator with a second generally rigid structure of the opto-isolator, the first generally rigid structure having a proximal end that is joined with a first housing of the opto-isolator and having a distal end that extends away from the first housing, the first housing being mechanically coupled with the first circuit board and having at least a first optical transmitter device therein, the second generally rigid structure having a proximal end that is joined with a second housing of the opto-isolator and having a distal end that extends away from the second housing, the second housing having an optical receiver device therein, the second housing being mechanically coupled to the second circuit board;
with the optical transmitter, converting an electrical signal into an optical signal;
with an optical waveguide of the opto-isolator, carrying the optical signal from the optical transmitter to the optical receiver, the optical waveguide having an optical axis that is coaxial with a longitudinal axis of the first generally rigid structure; and
with the optical receiver, receiving the optical signal as the optical signal passes out of an end of the optical waveguide and converting the optical signal into an electrical signal.
